(19) United States
(12) Patent Application Publication
(10) Pub. No.: US 2009/0293085 A1
(43) Pub. Date: Nov. 26, 2009

(54) Remote fed advertising system for point-of-sale

(75) Inventors: Kenneth S. Bailey, Newport Beach, CA (US); Paul Mula, San Jose, CA (US)

Correspondence Address: Law Office of Scott C Harris Inc, PO Box 1389, Rancho Santa Fe, CA, 92067, US

(73) Assignee: Clear-View-Technologies, Inc

(21) Appl. No.: 12/469,550

(22) Filed: May 20, 2009

Related U.S. Application Data
(60) Provisional application No. 61/054,695, filed on May 20, 2008.

(51) Int. Cl. H04N 7/025; G06F 3/041; G06Q 30/00

(52) U.S. Cl. 725/32; 345/173; 705/14.41; 725/60; 725/68

(57) ABSTRACT

Advertising content is received over a channel and displayed on the same terminal that displays the point of sale information.

This application claims priority from provisional application No. 61/054,695, filed May 20, 2008, the whole contents of the disclosure of which is herewith incorporated by reference.

### BACKGROUND

Alcohol and tobacco advertisers have poured billions of dollars into national advertising campaigns designed to increase public awareness of their products and thereby increase sales. Last year in the United States alone, bottling companies spent a record of over 1.75 billion in 2007.

Each year, the alcohol industry spends more than a billion dollars on “measured media” advertising, that is, television, radio, print, and outdoor ads. The available evidence indicates that more than 300 wine brands, 350 beer brands, and 1,400 distilled spirits brands are marketed to the U.S. Fewer than a quarter of them are advertised through measured media each year.

Alcohol promotions are often carried out in unconventional ways, including:

Sponsorship of cultural, musical, and sporting events;

Internet advertising;

Point-of-sale material, including window and interior displays at retail outlets, bars, and restaurant;

Distribution of brand-logoed items such as t-shirts, hats, watches, and glassware;

Product placements in movies and TV shows;

Catalogs and other direct mail communications;

Price promotions such as sales, coupons, and rebates; and

Trade promotions directed at wholesalers and retailers

Recently local banks, sports bar and various nightclubs have started placing plasma screens or flat panel Televisions in public view and displaying channels like CNN or the Sports Channel.

### SUMMARY

The present application describes a system that uses the same monitor screen for bar functions, e.g, entry of an order, or display of an action in the bar, and also for displaying advertisements. The advertisements can be received over transmissions, and creates advertisements based on the received transmissions.

According to an embodiment, the transmissions are received over a satellite link.

### BRIEF DESCRIPTION OF THE DRAWINGS

FIG. 1 depicts screens as might be installed in a typical nightclub environment.

FIG. 2 depicts the end to end systems components as are intended to be included.

FIG. 3A depicts an embodiment of an individual screen in advertising mode and

FIG. 3B depicts an example of the screen in the POS terminal mode.

FIG. 4 depicts an embodiment of the system flow of operations at a typical nightclub site.

FIG. 5 depicts an embodiment of the value of the system to the advertiser placing ads on the system.

### DETAILED DESCRIPTION

Display screens in nightclubs and bars display various images. The flat screens normally depict images of dancers in the building or prerecorded disco videos or streaming light images for special effects. This or other similar screens can be used by the bartender to ring up sales and/or make orders.

In an embodiment, each time the bartender rings up a sale, the touch screen becomes a computer keyboard. When the bartender steps away from the touch screen, the screen saver becomes a miniature billboard which displays advertising for various brands of alcohol or beer. In one embodiment, this system is fed via a satellite dish which updates the ads periodically either by venue, by region, by day of the week, or globally all at once.

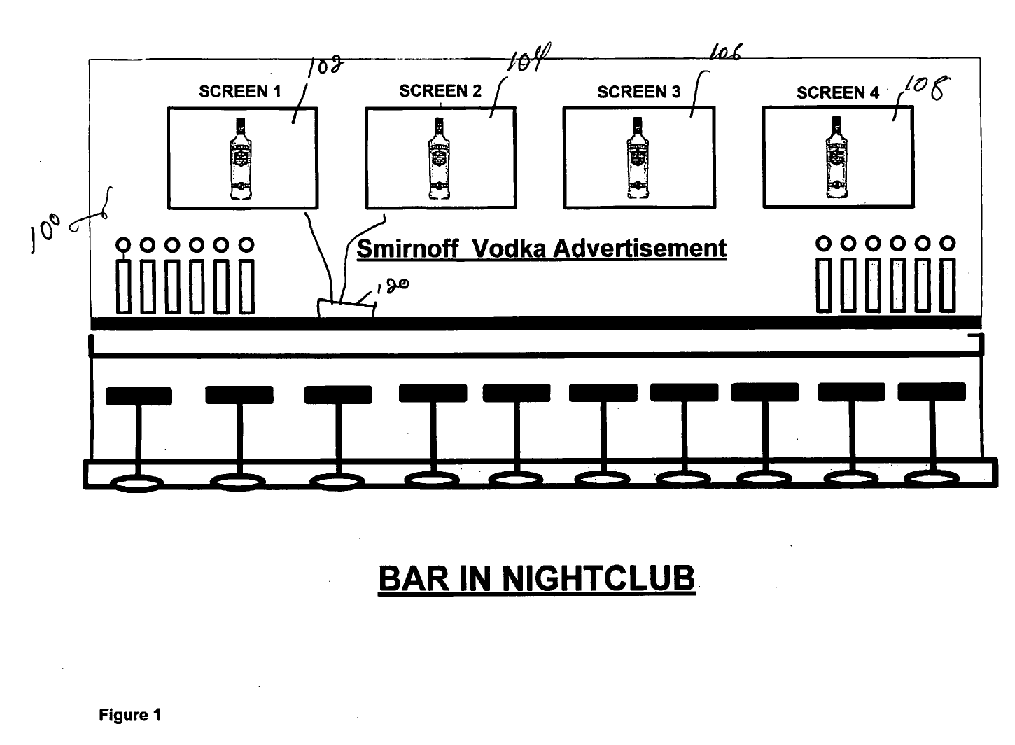

FIG. 1 shows the layout of a typical bar, 100, which may include a number of display devices. The bar 100 shows four screens 102, 104, 106 and 108. In this embodiment, the screens show their own advertisements at times between when they are being used for some other purpose. For example, touchscreens can be used for ringing up customers payment. The screen 102 could be a touchscreen for ordering drinks, or a screen of information, or screen about upcoming events. When not being used, the screen forms a miniature billboard that entices the clients using advertisements about items that are occurring in the bar. For example, when the bar's well drinks are “Smirnoff”, a Smirnoff vodka advertisement is presented. The system provides an advertisement that is tied to the content of what the bar is serving or wanting to serve—providing targeted advertisements.

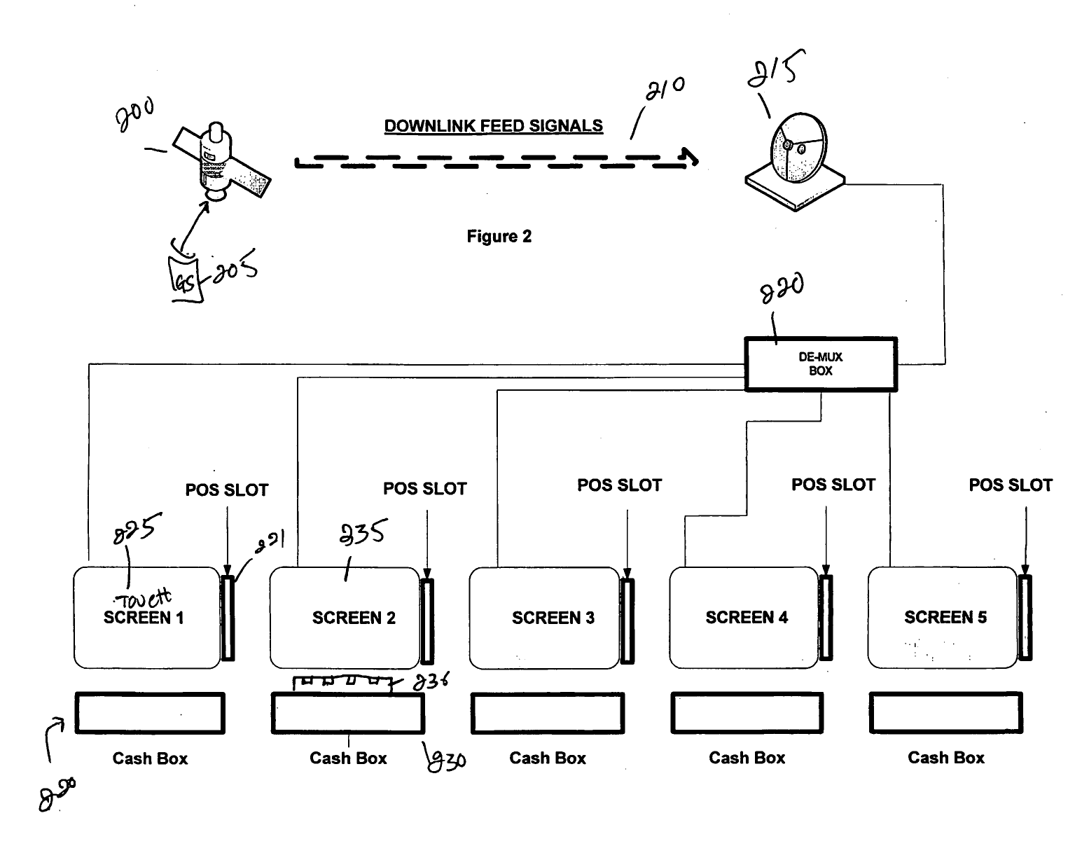

FIG. 2 shows an alternative embodiment, and also shows an end to end version of the system. A satellite 200 may receive information from a ground station such as 205, which can itself be provided in a conventional way. Information from the satellite is downlinked to a satellite receiver 215. The information from the satellite receiver is sent to a demultiplexing box 220. In an embodiment, the satellite can be Q band satellite that receives a transmission from the transmission feed on a periodic basis, for example, hourly, weekly, daily or monthly. The ads can also be updated by venue, region, day of the week, or the like. For example, different bars may offer different specials on different days, and ads related to those specials could be displayed.

A number of different point-of-sale cash boxes such as 220 are also provided. Each cashbox may include a point-of-sale slot 221 through which a user slide their ID device such as an ID card. At this point, the screen 225 becomes a screen used for the sale, e.g. a touchscreen as in 225. In the cash machine 230, the screen 235 is a conventional screen, and there is also a user interface 236 that allows the user to enter a command such as on the keyboard. In operation, the bartender can slide ID information into the point-of-sale slot 221, in which case the screen 225 becomes a screen associated with obtaining sales. When the sale is completed, the screen reverts to being an advertisement screen. The advertisement advertises items associated with the bar's sales.

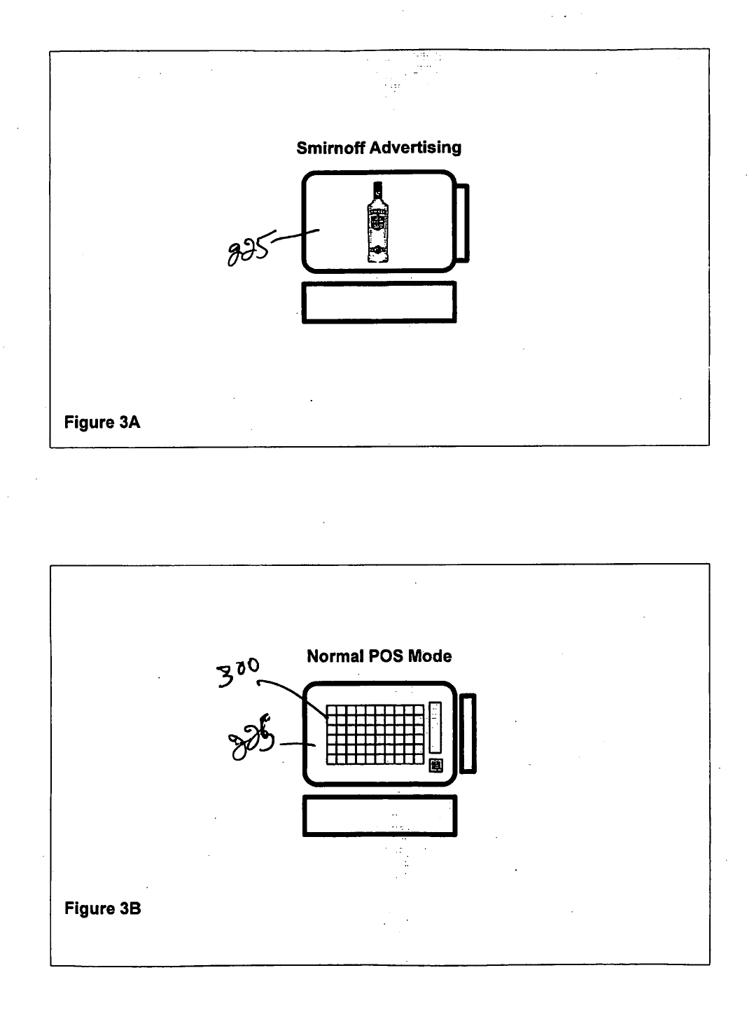

FIG. 3A shows the crossover, where FIG. 3A shows the screen 225 displaying Smirnoff advertising, and FIG. 3B shows the screen 225 in its normal point-of-sale mode, displaying a touchscreen matrix 300.

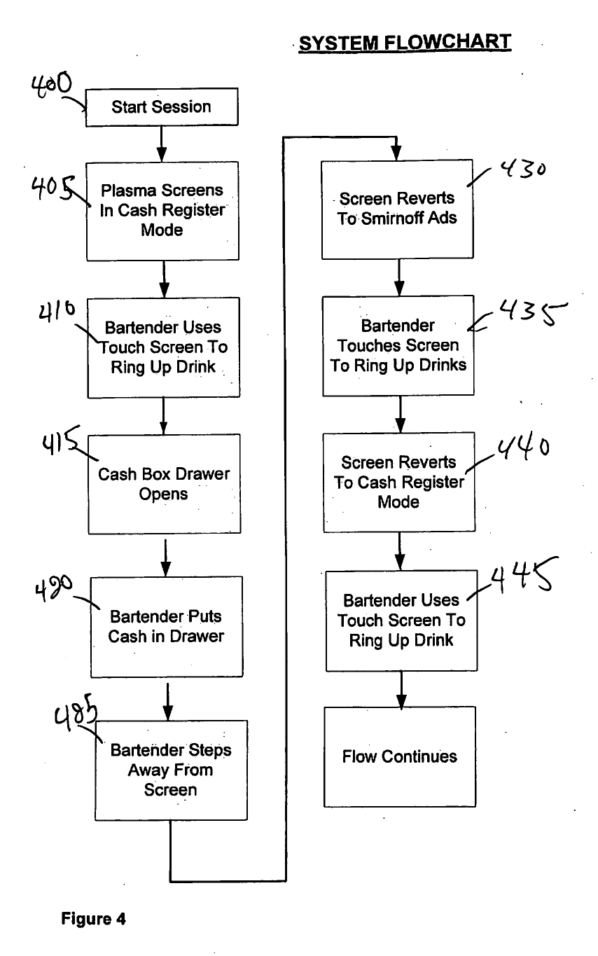

The system operates as shown in the flowchart of FIG. 4, which may be executed by a central processor such as 120, which provides output to all the different screens, e.g, the same output to all the screens, or individual displays to the individual screens. After the session is started at 400, the screens initially go into cash register mode at 405, allowing a bartender to use the cash register to ring up a drink at 410 using the display to carry out the checkout. The cashbox drawer then opens at 415 (or allows a swipe of an owner's credit card), and the bartender executes the transit the transaction at 420, then stepping away from the screen at 425. After the screen has not been used for a certain amount of time, at 430, the screen reverts to the display of advertisements of the periodically updated content. The ads can be shown to any user within range. At any time such as 435, when the bartender wants to ring up a drink, they touch the screen, causing device to revert at 442 to cash register mode. At 445, the bartender can use the touchscreen to ring up a drink for example.

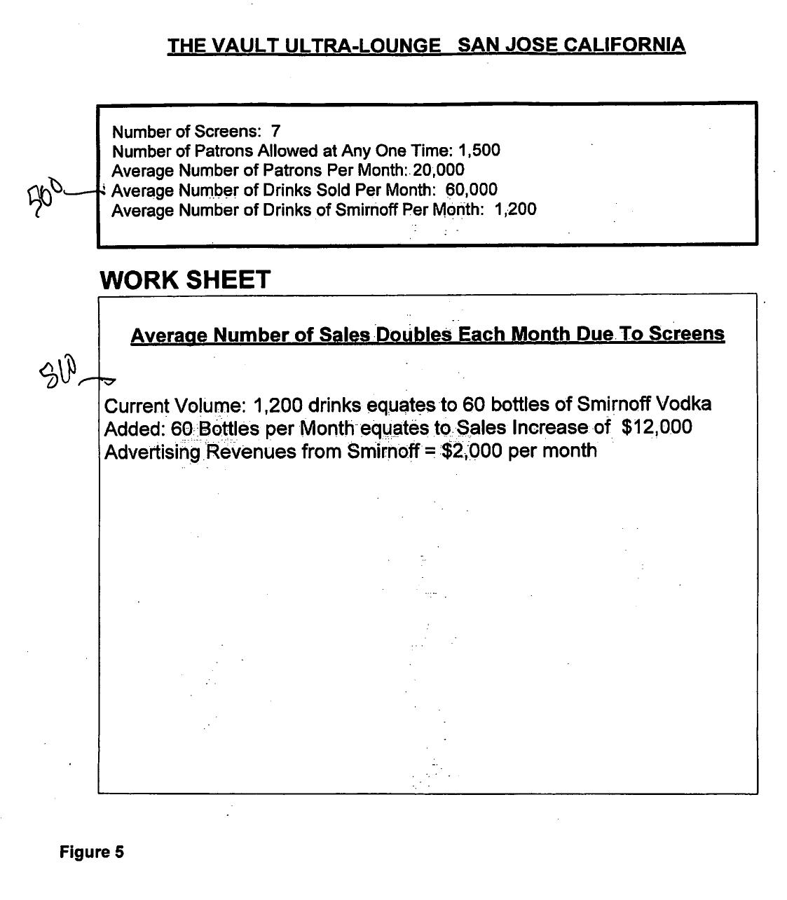

In one embodiment, illustrated with reference to FIG. 5, the price for the advertising may be computed based on the increased sales from the advertising. For example, taking an example of a bar called the Vault Ultra Lounge in FIG. 5, a before and after scenario may be shown. Step 500 shows the scenario before the advertising is carried out. The total number of drinks served per month is 60,000 and the number of drinks which used Smirnoff per month is 1200. Again, this is the baseline before the advertising.

510 shows an “after” scenario; where an additional 1200 drinks have been sold, which equates to 60 bottles of Smirnoff. The “after” scenario on the advertising provides a sales increase of another 1200 drinks.

In the embodiment of FIG. 5, the advertiser provides ⅙ of the increased revenue as a fee for the advertising. Of course, other numbers can be used for this analysis. Smirnoff pays an advertising fee of ⅙ of the extra, or $2000.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other components can be used. While the above describes a location system for anti theft, the same kind wireless battery or solar powered devices can be used for other applications. While the above has described very specific forms of structure and networks that can be used, other network protocols, including but not limited to Bluetooth and others can be similarly and analogously used. In addition, other applications for this system are possible and are contemplated by the present application. While the above describes Smirnoff, it should be understood that any other product can be similarly advertised. In embodiments, the product that is advertised is preferably a product that is available for sale at the advertising location, and more preferably is a food or drink for sale at the location.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. An advertising and ordering system, comprising:
a terminal, having an input device, which allows inputting information for purchasing a food item, said terminal having a screen, and said terminal running a program that selects a purchase to be entered by an employee in a first operating mode, and displays an advertisement on said screen in a second operating mode.

2. A system as in claim 1, further comprising a receiver, which receives advertising content over a channel, and wherein the advertisement that is displayed on said screen is based on the advertising content received over the channel.

3. A system as in claim 2, wherein said advertising content that is received over the channel periodically changes, and said advertisement which is displayed periodically changes based on the advertisement that is received over the channel.

4. A system as in claim 2, wherein the information that is received over the channel includes different advertising content for different periods, and a different advertising content is displayed at a different period.

5. A system as in claim 1, wherein said input device allows purchasing information for purchasing a specific alcoholic beverage, and said advertising content includes advertisements for said specific alcoholic beverage.

6. A system as in claim 5, further comprising charging an advertiser an amount which is based on an amount of increased sales attributable to an increase in purchases that occur responsive to said advertising.

7. A system as in claim 2, wherein said channel is a satellite channel.

8. A system as in claim 2, wherein said screen shows a point-of-sale touchscreen in the first mode, and shows advertising in the second mode, and wherein in the advertising is for an item which can be sold on the point-of-sale touchscreen.

9. A system as in claim 8, wherein said second mode with said advertisement is automatically entered after a point of sale transaction on said point-of-sale touchscreen is completed.

10. An method of advertising, comprising:
using a terminal device for inputting information for purchasing a food item in a first mode of operation of said terminal device;
displaying information from said inputting on a screen associated with said terminal device in said first mode;
using a computer for automatically detecting that said terminal device is no longer being used for inputting information; and
based on said automatically detecting, operating in a second mode which automatically displays an advertisement on the same screen that displayed said information in said first mode.

11. A method as in claim 10, further comprising a receiver, which receives advertising content over a channel, and wherein the advertisement that is displayed on said screen is based on the advertising content received over the channel.

12. A method as in claim 11, wherein said advertising content that is received over the channel periodically changes, and information displayed as said advertisement periodically changes based on the advertisement that is received over the channel.

13. A method as in claim 10, wherein the information that is received over the channel includes different advertising content for different periods, and a different advertising content is displayed at a different period.

14. A method as in claim 10, wherein said input device controls entry of purchasing information for purchasing a specific alcoholic beverage, and said advertising content includes advertisements for said specific alcoholic beverage.

15. A method as in claim 14, further comprising charging an advertiser an amount which is based on an amount of increased sales attributable to an increase in purchases that occur responsive to said advertising.

16. A method as in claim 11, wherein said channel is a satellite channel.

17. A method as in claim 11, further comprising showing a point-of-sale touchscreen in the first mode, and showing advertising in the second mode, and wherein in the advertising is for an item which can be sold on the point-of-sale touchscreen.

18. A method as in claim 10, further comprising using a computer for determining an increase in sales attributable to said advertisement, and charging a fee for said advertisement based on said increase in sales.

19. An method of advertising, comprising:
sending content over a channel to a bar;
determining an increase of sales at said attributable to said content; and
charging a fee as a percentage of said increase in sales.

20. A method as in claim 19, wherein said content is an advertisement.
